(19) United States
(12) Patent Application Publication
(10) Pub. No.: US 2019/0131792 A1
(43) Pub. Date: May 2, 2019

(54) CONTROL APPARATUS, CONTROL METHOD, AND NON-TRANSITORY STORAGE MEDIUM

(71) Applicant: NEC Corporation, Tokyo (JP)

(72) Inventor: Hidekazu KIMURA, Tokyo (JP)

(73) Assignee: NEC Corporation, Tokyo (JP)

(21) Appl. No.: 16/086,700

(22) PCT Filed: Feb. 10, 2017
(86) PCT No.: PCT/JP2017/004875

§ 371 Date: Sep. 20, 2018

(30) Foreign Application Priority Data
Mar. 23, 2016 (JP) 2016-058002

(51) Int. Cl. H02J 3/32; H02J 3/38; H02J 7/00; G05B 13/02

(52) U.S. Cl. CPC H02J 3/32; G05B 13/026; H02J 7/0021; H02J 3/38

(57) ABSTRACT

The present invention provides a control apparatus (10) including a determination unit (11) that determines charge electric power to be charged in a storage battery and/or output electric power to be output from the storage battery, on the basis of generation electric power of an electric power generation apparatus, and a decision unit (12) that decides a storage battery to be controlled that is the storage battery for charging the charge electric power and/or outputting the output electric power, on the basis of a positional relationship between the electric power generation apparatus and a plurality of storage batteries.

### TECHNICAL FIELD

The present invention relates to a control apparatus, a control method, and a program.

### BACKGROUND ART

An electric power generation apparatus that generates electric power using renewable energy such as a solar electric power generation apparatus or a wind power electric power generation apparatus (hereinafter referred to as “RE electric power source”) is known. In addition, an RE electric power source connected to an electric power system rapidly increases due to the fact that fixed price purchase (FIT) began which requires an electric power company to purchase electric power generated by the RE electric power source at a fixed price.

A situation is assumed that in a case where the RE electric power source connected to the electric power system increases, an electric power supply becomes excessive with respect to an electric power demand. As a method of avoiding this situation, a method of suppressing generation electric power (output suppression) of the RE electric power source is considered.

Patent Document 1 discloses a technique using surplus electric power (electric power to be suppressed) for heating in a case where an electric water heater can perform heating when the electric power generation apparatus is notified of the output suppression.

### RELATED DOCUMENT

### Patent Document

[Patent Document 1] Japanese Patent Application Publication No. 2015-106937

### SUMMARY OF THE INVENTION

### Technical Problem

In the invention of Patent Document 1, it is assumed that an electric power generation apparatus and the electric water heater are provided together, and in a state where the together provided electric water heater cannot perform heating, it is impossible to consume (use) the surplus electric power.

That is, Patent Document 1 does not disclose the consumption of surplus electric power performed by storage batteries spread over a wide area. Therefore, in a case where a storage battery is not suitably selected, a variation of voltage or frequency occurs. Thus, there is a state in which it is impossible to reverse a flow from an electric power generation apparatus connected to an electric power distribution network to the electric power distribution network, or a problem that electric equipment operated by the electric power is affected.

An object of the present invention is to provide a technique for suppressing the occurrence of an increase of voltage or a variation of frequency.

### Solution to Problem

According to the present invention, a control apparatus including a determination unit that determines charge electric power to be charged in a storage battery and/or output electric power to be output from the storage battery, on the basis of generation electric power of an electric power generation apparatus, and a decision unit that decides a storage battery to be controlled that is the storage battery for charging the charge electric power and/or outputting the output electric power, on the basis of a positional relationship between the electric power generation apparatus and a plurality of storage batteries is provided.

In addition, according to the present invention, a control method executed in a control apparatus that manages a plurality of storage batteries, and including determining charge electric power to be charged in the storage battery and/or output electric power to be output from the storage battery, on the basis of generation electric power of an electric power generation apparatus, and deciding a storage battery to be controlled that is the storage battery for charging the charge electric power and/or outputting the output electric power, on the basis of a positional relationship between the electric power generation apparatus and the plurality of storage batteries is provided.

In addition, according to the present invention, a program causes a computer to determine charge electric power to be charged in the storage battery and/or output electric power to be output from the storage battery, on the basis of generation electric power of an electric power generation apparatus, and decide a storage battery to be controlled that is the storage battery for charging the charge electric power and/or outputting the output electric power from among a plurality of storage batteries, on the basis of a positional relationship with the electric power generation apparatus is provided.

### Advantageous Effects of Invention

According to the present invention, it is possible to suppress an occurrence of an increase of voltage and a variation of frequency.

### BRIEF DESCRIPTION OF THE DRAWINGS

The above objects, other objects, features, and advantages will be more apparent by the following preferable example embodiment and the accompanying drawings.

FIG. 1 is a diagram conceptually illustrating an example of a hardware configuration of an apparatus of the present example embodiment.

FIG. 2 is a diagram for describing an overall image of a control system of the present example embodiment.

FIG. 3 is an example of a functional block diagram of a control apparatus of the present example embodiment.

FIG. 4 is a diagram schematically illustrating an example of information handled by the control apparatus of the present example embodiment.

FIG. 5 is a diagram schematically illustrating an example of the information handled by the control apparatus of the present example embodiment.

FIG. 6 is a diagram for describing an example of a process of the control apparatus of the present example embodiment.

FIG. 7 is a diagram schematically illustrating an example of the information handled by the control apparatus of the present example embodiment.

FIG. 8 is a diagram schematically illustrating an example of the information handled by the control apparatus of the present example embodiment.

FIG. 9 is a flowchart schematically illustrating an example of a flow of the process of the control apparatus of the present example embodiment.

FIG. 10 is a diagram schematically illustrating an example of the information handled by the control apparatus of the present example embodiment.

FIG. 11 is a flowchart schematically illustrating an example of the flow of the process of the control apparatus of the present example embodiment.

FIG. 12 is a flowchart schematically illustrating an example of the flow of the process of the control apparatus of the present example embodiment.

FIG. 13 is a flowchart schematically illustrating an example of the flow of the process of the control apparatus of the present example embodiment.

FIG. 14 is a diagram for describing an application example of the control system of the present example embodiment.

### DESCRIPTION OF EMBODIMENTS

First, an example of a hardware configuration of an apparatus (control apparatus) of the present example embodiment will be described. Each unit included in the apparatus of the present example embodiment is configured with any combination of hardware and software centering on a Central Processing Unit (CPU) of any computer, a memory, a program loaded into the memory, a storage unit such as a hard disk that stores the program (capable of storing a program downloaded from a storage medium such as a Compact Disc (CD) or a server or the like on the Internet, besides a stored program from a stage of shipping the apparatus in advance), and an interface for network connection. In addition, it is understood by those skilled in the art that there are various modifications in realization method and apparatus thereof.

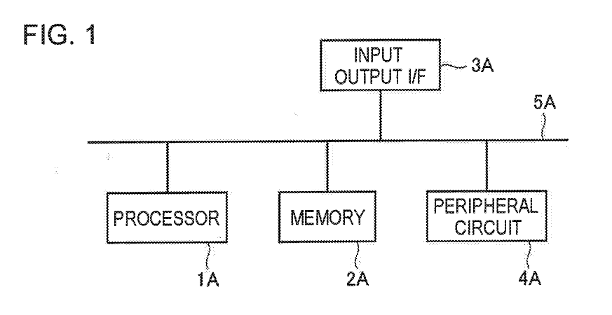

FIG. 1 is a block diagram illustrating the hardware configuration of the apparatus of the present example embodiment. As shown in FIG. 1, the apparatus has a processor 1A, a memory 2A, an input and output interface 3A, a peripheral circuit 4A, and a bus 5A. Various modules are included in the peripheral circuit.

The bus 5A is a data transmission path through which the processor 1A, the memory 2A, the peripheral circuit 4A, and the input and output interface 3A mutually transmit and receive data. For example, the processor 1A is a processor such as a Central Processing Unit (CPU) or a Graphics Processing Unit (GPU). For example, the memory 2A is a memory such as a Random Access Memory (RAM) or a Read Only Memory (ROM). The input and output interface 3A includes an interface for acquiring information from an external apparatus, an external server, an external sensor, and the like. The processor 1A outputs an instruction to each module and performs an arithmetic operation on the basis of an arithmetic operation result.

Hereinafter, the present example embodiment will be described. Note that a functional block diagram used in the following description of the present example embodiment shows function-based blocks not hardware-based configurations. In such figures, it is described that each apparatus is configured with one device, however, configuration means thereof is not limited thereto. That is, each apparatus may be configured to be physically separated or logically separated. Note that the same reference numerals are given to the same elements, and the description thereof will be suitably omitted.

### First Example Embodiment

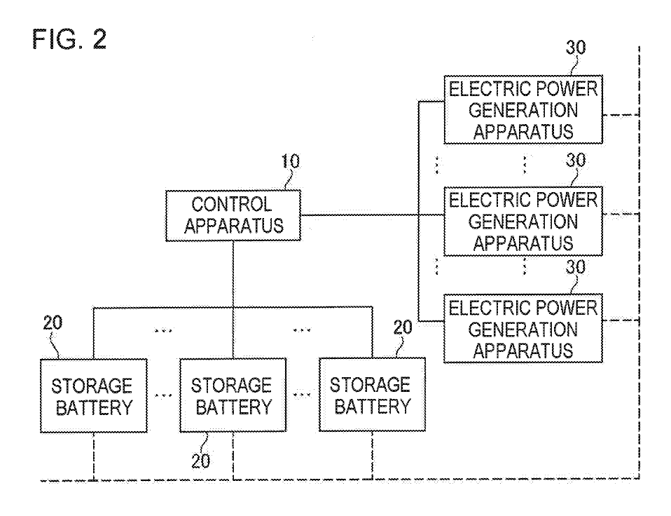

First, the overall image of a control system of the present example embodiment will be described using FIG. 2. As shown in the drawing, the control system has a control apparatus 10, a plurality of storage batteries 20, and a plurality of electric power generation apparatuses 30. A solid line indicates a communication line (a network such as the Internet) and a dotted line indicates an electric power line. An apparatus group connected by the communication line can mutually transmit and receive information.

The electric power generation apparatus 30 is an apparatus that generates electric power using natural energy (sunlight, wind power, geothermal, and the like). The storage battery 20 is an apparatus in which electric power is charged and from which electric power is output (discharged). Configurations of the storage battery 20 and the electric power generation apparatus 30 may adopt any configuration.

In the present example embodiment, electric power generation suppression information of the electric power generation apparatus 30 is decided in advance. For example, on the previous day, the electric power generation suppression information for the next day is decided. The control apparatus 10 determines electric power [W] and an electric power amount [Wh] to be charged in the storage battery 20 to be managed on the day (electric power generation suppression target day), on the basis of the electric power generation suppression information and an electric power generation prediction of the day of each electric power generation apparatus 30 to be managed. Here, a suppression target (surplus electric power and a surplus electric power amount) among predicted generation electric power [W] and a predicted generation electric power amount [Wh] of the day is determined as the electric power [W] and the electric power amount [Wh] to be charged in the storage battery 20 to be managed. In a case where the electric power generation suppression information is “electric power generation stop (output 0)”, the whole of the predicted generation electric power [W] and the predicted generation electric power amount [Wh] are the suppression targets. In this case, the whole of the predicted generation electric power [W] and the predicted generation electric power amount [Wh] are determined as the electric power [W] and the electric power amount [Wh] to be charged in the storage battery 20 to be managed.

After determining the electric power [W] and the electric power amount [Wh] to be charged in the storage battery 20 to be managed, the control apparatus 10 decides the storage battery 20 to be charged with the determined electric power [W] and electric power amount [Wh] from among a plurality of storage batteries 20 of which a charge process can be controlled. The control apparatus 10 decides the storage battery 20 to be charged, on the basis of a positional relationship with the electric power generation apparatus 30 that generates the surplus electric power. A suitable storage battery 20 is decided on the basis of the positional relationship, which contributes the stability of an electric power distribution network. Hereinafter, the configuration of the control apparatus 10 will be described in detail.

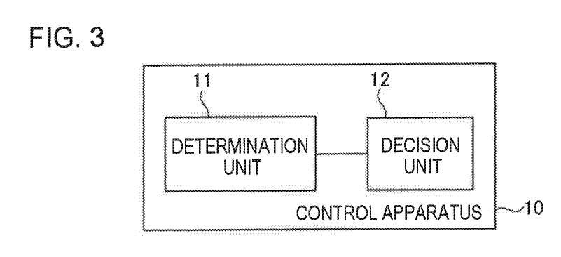

FIG. 3 illustrates an example of a functional block diagram of the control apparatus 10. As shown in the drawing, the control apparatus 10 has a determination unit 11 and a decision unit 12.

First, in the control apparatus 10, a plurality of storage batteries 20 to be managed and a plurality of electric power generation apparatuses 30 to be managed are registered. Surplus electric power by the plurality of electric power generation apparatuses 30 to be managed is charged by the plurality of storage batteries 20 to be managed.

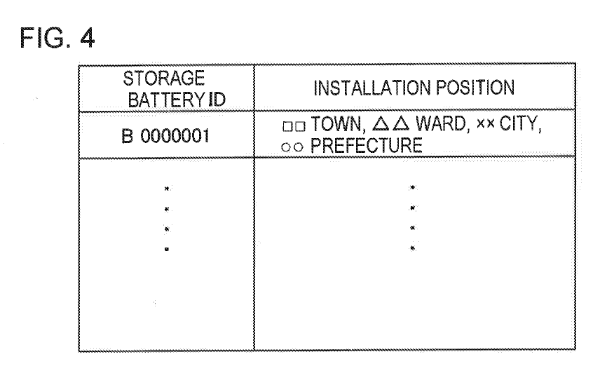

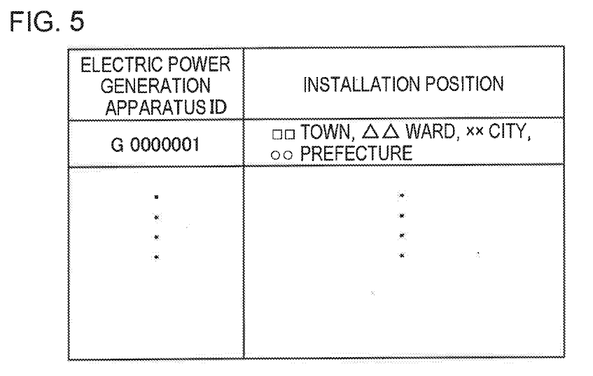

As shown in FIG. 4, installation positions of each of the plurality of storage batteries 20 to be managed are stored in the control apparatus 10. In addition, as shown in FIG. 5, installation positions of each of the plurality of electric power generation apparatuses 30 to be managed are stored in the control apparatus 10.

Returning to FIG. 3, the determination unit 11 determines the charge electric power to be charged in the storage battery 20 to be managed on the basis of the generation electric power of the electric power generation apparatus 30 to be managed. The determination unit 11 of the present example embodiment determines the charge electric power to be charged in the storage battery 20 to be managed on the basis of electric power generation suppression information for the electric power generation apparatus 30 to be managed and an electric power generation prediction of the electric power generation apparatus 30 at the timing at which the electric power generation is suppressed.

The electric power generation suppression information is decided in advance by a manager of the electric power distribution network. For example, on the previous day, the electric power generation suppression information for the next day is decided. For example, as a content of the electric power generation suppression, “electric power generation stop (output 0)” is considered. In this case, the electric power generation suppression information includes an electric power generation suppression time slot (for example, xx day ∘∘ month, from ΔΔ o'clock to □□o'clock of xx day ∘∘ month) in which the electric power generation suppression of such a content is executed.

In addition, as the content of the electric power generation suppression, instead of the “electric power generation stop” an example of setting “output upper limit value” is considered. In such a case, the electric power generation suppression information includes an electric power generation suppression content (for example: “output upper limit value: ΔΔ % of a rated output” or the like) and the electric power generation suppression time slot. The output upper limit value may be a common value in all of the electric power generation suppression time slots or may be set for every predetermined time (for example, every 30 minutes).

The determination unit 11 acquires the electric power generation suppression information for each electric power generation apparatus 30 to be managed. For example, the manager of the electric power distribution network may notify each electric power generation apparatus 30 (each manager of the electric power generation apparatus 30) of the electric power generation suppression information. In addition, the determination unit 11 may acquire each pieces of the electric power generation suppression information from each electric power generation apparatus 30 to be managed (from each manager of the electric power generation apparatus 30 to be managed). In addition, information for identifying the electric power generation apparatus 30 registered in the control apparatus 10 may be notified to the manager of the electric power distribution network in advance. In addition, the manager of the electric power distribution network may transmit the electric power generation suppression information for each electric power generation apparatus 30 registered in the control apparatus 10 to the control apparatus 10. In addition, an operator of the control apparatus 10 may input the electric power generation suppression information for each electric power generation apparatus 30 to be managed to the control apparatus 10 through any means.

In addition, the determination unit 11 acquires the electric power generation prediction of at least a part of the electric power generation apparatuses 30 to be managed. The determination unit 11 acquires at least the electric power generation prediction of the electric power generation apparatus 30 to which the electric power generation suppression information is notified. The determination unit 11 may acquire each electric power generation prediction from each electric power generation apparatus 30 to which the electric power generation suppression information is notified. In addition, the determination unit 11 may generate the electric power generation prediction of each electric power generation apparatus 30 to which the electric power generation suppression information is notified. In addition, the operator of the control apparatus 10 may input the electric power generation prediction of each electric power generation apparatus 30 to which the electric power generation suppression information is notified to the control apparatus 10 through any means.

The electric power generation prediction is an electric power generation prediction in the electric power generation suppression time slot specified by the electric power generation suppression information. For example, the electric power generation prediction may be information indicating a time change of the generation electric power [W] in the electric power generation suppression time slot. It is possible to calculate an electric power amount [Wh] of which the electric power generation is suppressed, on the basis of the information. The electric power amount [Wh] of which the electric power generation is suppressed may be an electric power amount [Wh] in the electric power generation suppression time slot.

The determination unit 1 determines the charge electric power [W] and the charge electric power amount [Wh] to be charged in the storage battery 20 to be managed on the day (electric power generation suppression day), on the basis of the electric power generation suppression information and the electric power generation prediction. For example, the determination unit 11 determines the suppression target (surplus electric power and surplus electric power amount) among the predicted generation electric power [W] and the predicted generation electric power amount [Wh] indicated by the electric power generation prediction as the electric power [W] and the electric power amount [Wh] to be charged in the storage battery 20 to be managed. The suppression target is determined on the basis of the electric power generation suppression information.

For example, in a case where the electric power generation suppression information is “electric power generation stop (output 0) during the electric power generation suppression time slot”, the predicted generation electric power [W] at each timing during the electric power generation suppression time slot is determined as the charge electric power [W] to be charged in the storage battery 20 to be managed at each timing. In addition, the predicted generation electric power amount [Wh] in the electric power generation suppression time slot is determined as the charge electric power amount [Wh] to be charged in the storage battery 20 to be managed.

In addition, in a case where the electric power generation suppression information set the output upper limit value such as “ΔΔ % of a rated output”, when the predicted generation electric power is greater than the output upper limit value, a difference between the predicted generation electric power and the output upper limit value is set as the surplus electric power and a surplus electric power amount during the time when the predicted generation electric power is greater than the output upper limit value is set as the surplus electric power amount. The surplus electric power and the surplus electric power amount are set as the electric power [W] and the electric power amount [Wh] to be charged in the storage battery 20.

Specifically, in a case where the output upper limit value is 50% of the rated value, the generation electric power of which the predicted generation electric power is greater than 50% of the rated output is set as the surplus electric power, and the electric power amount of the surplus electric power during the time when the predicted generation electric power is greater than 50% of the rated output is set as the surplus electric power amount. In addition, the surplus electric power and the surplus electric power amount are set as the electric power [W] and the electric power amount [Wh] to be charged in the storage battery 20.

Returning to FIG. 3, the decision unit 12 decides the storage battery 20 (storage battery to be controlled) to be charged with the charge electric power determined by the determination unit 11 from among the plurality of storage batteries 20 to be managed, on the basis of the positional relationship between the electric power generation apparatus 30 to which the electric power generation suppression information is notified (electric power generation apparatus 30 generating the surplus electric power) and each of the plurality of storage batteries 20 to be managed. For example, the decision unit 12 decides the storage battery to be controlled on the basis of a positional relationship between a section to which the electric power generation apparatus 30 is connected and a section to which the storage battery 20 is connected. Hereinafter, the electric power generation apparatus 30 to which the electric power generation suppression information is notified and from which the surplus electric power is generated is referred to as “first electric power generation apparatus 30”.

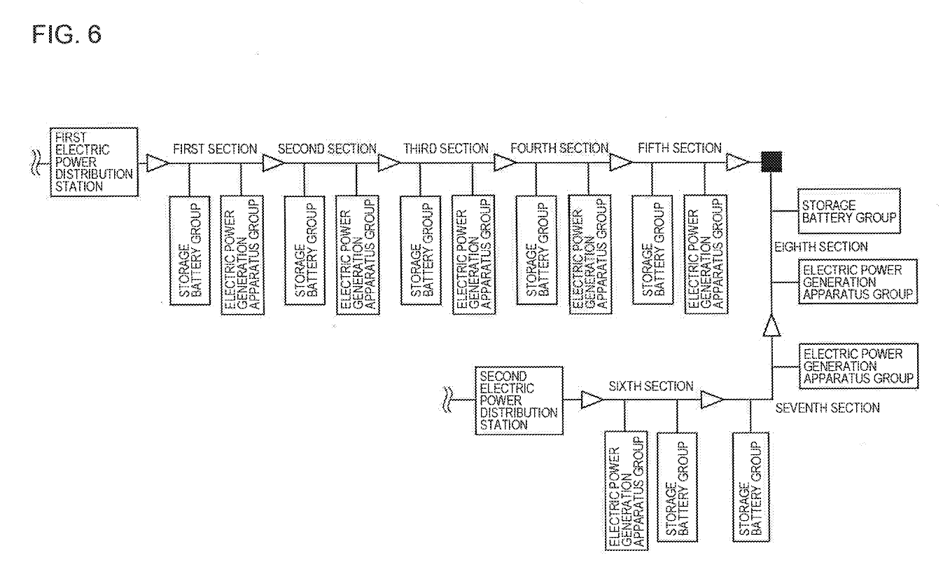

Hereinafter, an example of deciding process by the decision unit 12 will be described. As shown in FIG. 6, the electric power distribution network is divided into a plurality of sections by a switch. In the drawing, triangles and filled quadrangles indicate the switches. The triangle switch is in an open state. On the other hand, the filled quadrangle switch is in a closed state.

In the drawing, the electric power distribution network is divided into first to eighth sections. The first to fifth sections receive an electric power supply from a first electric power distribution station. The sixth to eighth sections receive the electric power supply from a second electric power distribution station. A plurality of electric power generation apparatus groups and electric power storage apparatus groups are connected to each section. In a case where an electric power distribution accident occurs in a section, open or close state of the switch is switched, and the section where the accident occurred is cut off.

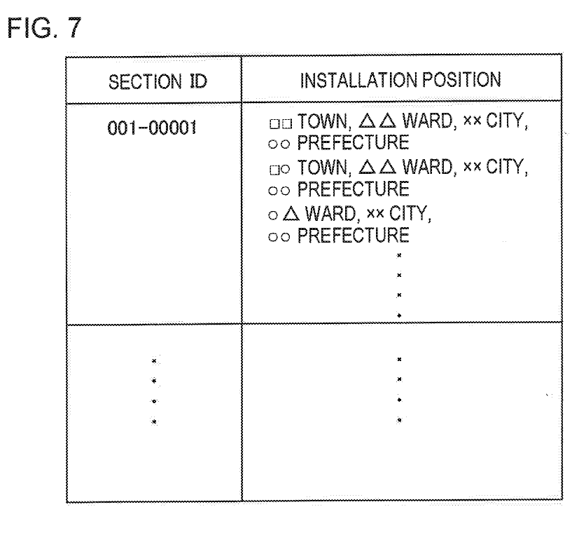

The control apparatus 10 of the present example embodiment holds information for identifying the section to which each of the plurality of storage batteries 20 to be managed and each of the plurality of electric power generation apparatuses 30 to be managed is connected. For example, as shown in FIG. 7, the control apparatus 10 may hold information in which each section is associated with an address corresponding to each section. In addition, using the information and information indicating the installation positions of each storage battery 20 and each electric power generation apparatus 30 (refer to FIG. 4 and FIG. 5), the control apparatus 10 may determine the section to which each storage battery 20 and each electric power generation apparatus 30 are connected.

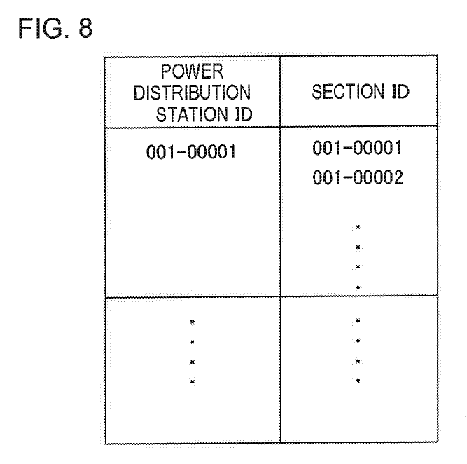

In addition, the control apparatus 10 of the present example embodiment holds information for identifying the electric power distribution station that supplies electric power to each of the plurality of sections at the present time. For example, as shown in FIG. 8, the control apparatus 10 may hold information in which the electric power distribution station is associated with a section in which each electric power distribution station supplies electric power. In addition, the control apparatus 10 may hold information indicating a connection way of sections as shown in FIG. 6.

In addition, the control apparatus 10 of the present example embodiment may hold attribute information of each of the plurality of storage batteries 20. The attribute information includes a decision between the manager of the control apparatus 10 and the manager of each of the plurality of storage batteries 20. For example, an empty capacity [Wh] decided to be secured in each storage battery 20 for a charge control by the control apparatus 10 or a charge electric power maximum value [W] controllable by a charge control performed by the control apparatus 10 is considered.

The decision unit 12 decides the storage battery to be controlled on the basis of the above information. Specifically, the decision unit 12 decides the storage battery 20 connected to the same section as the first electric power generation apparatus 30 as the storage battery to be controlled.

For example, the determination unit 11 described above calculates a time change of total surplus electric power [W] and a total surplus electric power amount [Wh] of the first electric power generation apparatus 30 connected to each section, for each section. The time change of the total surplus electric power [W] is obtained by adding the surplus electric power [W] at each timing of each of the plurality of first electric power generation apparatuses 30 on each timing. The total surplus electric power amount [Wh] is calculated on the basis of the time change of the total surplus electric power [W]. The time change of the total surplus electric power [W] and the total surplus electric power amount [Wh] are determined as a time change of the charge electric power and the charge electric power amount [Wh] to be charged in the storage batteries.

As the storage batteries 20 (storage batteries to be controlled) in which the total surplus electric power [W] and the total surplus electric power amount [Wh] of a section are charged, the decision unit 12 decides the storage batteries 20 connected to the section.

In a case where it is impossible to completely charge the total surplus electric power and the total surplus electric power amount described above in the storage batteries 20 (storage batteries to be controlled) connected to the same section, the decision unit 12 may further decide the storage batteries 20 connected to another section to which electric power is supplied from the same electric power distribution station as the electric power distribution station supplying electric power to the section, as the storage batteries to be controlled.

Here, as the “case where it is impossible to completely charge the total surplus electric power and the total surplus electric power amount described above”, for example, a “case where a sum of the controllable charge electric power maximum values [W] of storage batteries to be controlled is less than the above-described total surplus electric power at any timing in the electric power generation suppression time slot”, a “case where a sum of the maximum values [Wh] of the controllable empty capacities of storage batteries to be controlled is less than the above-described total surplus electric power amount”, and the like are considered. The controllable charge electric power value [W] may be the rated value of each storage battery to be controlled or may be a value indicated in the decision included in the attribute information of the storage battery 20 described above (the charge electric power maximum value [W] controllable by the charge control performed by the control apparatus 10). In addition, the maximum value [Wh] of the controllable empty capacity may be a rated capacity of each storage battery to be controlled or may be a value indicated in the decision included in the attribute information of the storage battery 20 described above (the empty capacity decided to be secured).

For example, in a case where it is impossible to completely charge the total surplus electric power and the total surplus electric power amount of the fourth section shown in FIG. 6 in the storage batteries 20 (storage batteries to be controlled) connected to the fourth section, the decision unit 12 may further decide the storage batteries 20 connected to any of the first, second, third, and fifth sections receiving electric power supply from the same electric power distribution station as the fourth section (in a case of the drawing, a first electric power distribution station), as the storage batteries to be controlled.

In this case, the decision unit 12 may decide the storage batteries 20 connected to a section closer to the section where the surplus electric power is generated as the storage batteries to be controlled more preferentially than other storage batteries 20, among a plurality of sections to which the electric power is supplied from the same electric power distribution station.

For example, in the example described above, the decision unit 12 decides the storage batteries 20 connected to the third and fifth sections as the storage batteries to be controlled more preferentially than the storage batteries 20 connected to the first and second sections.

Here, “preferentially deciding as the storage batteries to be controlled” will be described. In a case of the example described above, an amount that cannot be charged in the storage batteries 20 in the fourth section anole is charged in the storage batteries 20 connected to any of the first, second, third, and fifth sections. Depending on the value of the amount that cannot be charged in the storage batteries 20 of the fourth section alone, all storage batteries 20 connected to the first, second, third, and fifth sections may not be necessarily set as the storage batteries to be controlled, and a part of all storage batteries 20 may be set as the storage batteries to be controlled in some cases. In such a case, the decision unit 12 decides the storage battery 20 in order (preferentially) from the storage battery 20 that is connected to the closer section, as the storage battery to be controlled.

After deciding the storage batteries to be controlled, the decision unit 12 may decide a charge schedule (a time change of the electric power [W] to be charged) of each storage battery to be controlled and notify each storage battery to be controlled of the charge schedule. For example, the total surplus electric power [W] at each timing may be equally divided among the plurality of storage batteries to be controlled. In addition, the total surplus electric power [W] at each timing may be proportionally divided among the plurality of storage batteries to be controlled according to a ratio of the controllable charge electric power maximum value [W] or the maximum value [Wh] of the controllable empty capacity of the storage battery to be controlled.

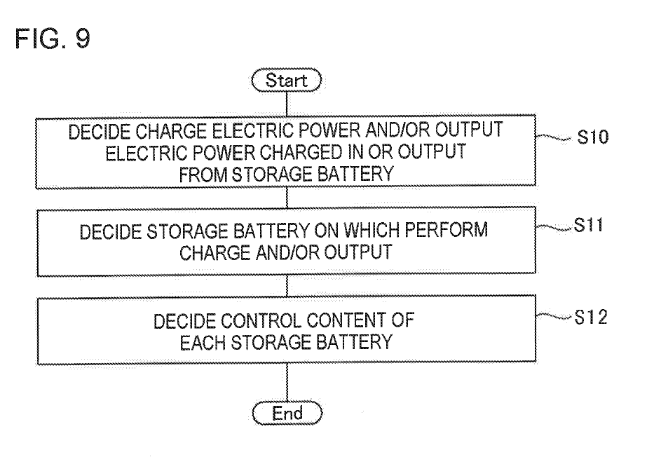

Next, an example of a flow of a process of the control apparatus 10 of the present example embodiment will be described using a flowchart of FIG. 9.

First, the determination unit 11 determines the charge electric power and the charge electric power amount to be charged in the storage battery 20 on the basis of the electric power generation suppression information and the electric power generation prediction of the electric power generation apparatus 30 to be managed (S10).

Then, the decision unit 12 decides the storage battery 20 (storage battery to be controlled) in which the charge electric power determined in S10 is charged from among the plurality of storage batteries 20 to be managed, on the basis of the positional relationship between the electric power generation apparatus 30 and the storage battery 20 (S11).

Then, the decision unit 12 decides the charge schedule of each storage battery to be controlled decided in step S11 and notifies each storage battery to be controlled of the charge schedule (S12).

The processes of S10 to S12 are executed before the electric power generation suppression time slot indicated by the electric power generation suppression information. In addition, during the electric power generation suppression time slot, the storage battery to be controlled executes a charge process according to the charge schedule notified in S12. In addition, the electric power generation apparatus 30 to which the electric power generation suppression information is notified performs electric power generation and output (reverse flow) to the electric power distribution network without performing an electric power generation suppression.

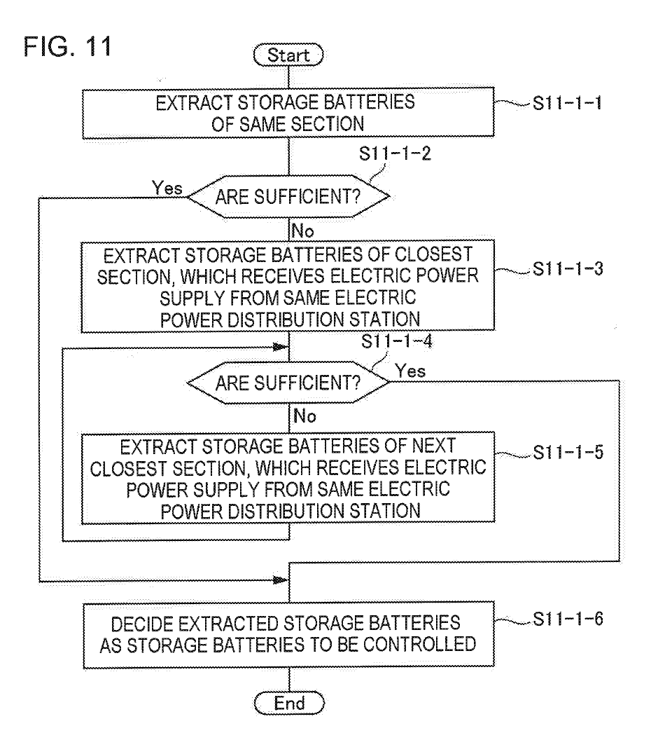

Next, an example of a process of S I will be described using a flowchart of FIG. 11.

First, in S10 of FIG. 9, for each section, the determination unit 11 calculates the time change of the total surplus electric power [W] and the total surplus electric power amount [Wh] of the first electric power generation apparatus 30 connected to each section. The time change of the total surplus electric power [W] and the total surplus electric power amount [Wh] are the time change of the charge electric power [W] and the charge amount [Wh] to be charged in the storage batteries 20. Here, it is assumed that the determination unit 11 calculates the time change of the total surplus electric power [W] and the total surplus electric power amount [Wh] of a process target section among the plurality of sections.

The decision unit 12 decides the storage batteries 20 in which the total surplus electric power and the total surplus electric power amount of the process target section are charged. First, the decision unit 12 extracts the storage batteries 20 connected to the process target section (S11-1-1). Then, the decision unit 12 determines whether or not the extracted storage batteries 20 are sufficient (S11-1-2).

For example, the decision unit 12 determines whether or not “first condition: the sum of the controllable charge electric power maximum values [W] of the extracted storage batteries 20 is greater than the total surplus electric power [W] at each timing” and “second condition: the sum of the maximum values [Wh] of the controllable empty capacities of the extracted storage batteries 20 is greater than the total surplus electric power amount [Wh]” are satisfied.

In a case where both of the first condition and the second condition are satisfied, the decision unit 12 determines that the extracted storage batteries 20 are sufficient. On the other hand, in a case where at least one condition is not satisfied, the decision unit 12 determines that the extracted storage batteries 20 are not sufficient.

In a case where it is determined that the extracted storage batteries 20 are sufficient (Yes in S11-1-2), all of the storage batteries 20 that are extracted at that time point are decided as the storage batteries to be controlled (S11-1-6) and ends the process of S11.

On the other hand, in a case where it is determined that the extracted storage batteries 20 are not sufficient (No in S11-1-2), the decision unit 12 further extracts the storage batteries 20 connected to the section closest to the process target section among the sections receiving the electric power supply from the same electric power distribution station as the process target section (S11-1-3). Then, the decision unit 12 determines whether or not the extracted storage batteries 20 are sufficient (S11-1-4). The process of S11-1-4 is the same as the process of S11-1-2.

In a case where it is determined that the extracted storage batteries 20 are sufficient (Yes in S11-1-4), all of the storage batteries 20 that are extracted at that time point are decided as the storage batteries to be controlled (S11-1-6) and ends the process of S11.

On the other hand, in a case where it is determined that the extracted storage batteries 20 are not sufficient (No in S11-1-4), the decision unit 12 further extracts the storage batteries 20 connected to the section next closest to the process target section among the sections receiving the electric power supply from the same electric power distribution station as the process target section (S11-1-5). Then, the decision unit 12 determines whether or not the extracted storage batteries 20 are sufficient (S11-1-4). Thereafter, the same process is repeated.

Next, an advantageous effect of the present example embodiment will be described. In a technique of charging the surplus electric power in the plurality of storage batteries 20 spread over a wide area, in a case where the storage battery 20 to be charged is not suitably selected, the following problem may occur. For example, although a balance between the electric power supplied to the electric power distribution network and the electric power consumed from the electric power distribution network is maintained by the charge process described above, a variation of a voltage or a frequency may occur in an electric power distribution line between the electric power generation apparatus 30 that has supplied the surplus electric power to the electric power distribution network and the storage battery 20 charged with the surplus electric power. For example, a voltage tends to be relatively high in the vicinity of the electric power generation apparatus 30 that has supplied the surplus electric power. In addition, a voltage tends to be relatively low in the vicinity of the storage battery 20 charged with the surplus electric power. Therefore, the frequency may vary.

The variation of the voltage or the frequency causes various disadvantages. For example, by the fact that a voltage of a predetermined place of the electric power distribution network is relatively high, a state in which the reverse flow to the electric power distribution network from the electric power generation apparatus 30 connected to the vicinity of the electric power distribution network is impossible may occur. In addition, the frequency variation may affect electric equipment operated by the electric power.

In a case where the distance between the electric power generation apparatus 30 that supplies the surplus electric power to the electric power system and the storage battery 20 to be charged with the surplus electric power is long, a range in which the variation of the voltage or the frequency described above may occur is widened. As a result, a range in which the disadvantages described above may occur is widened.

According to the present example embodiment described above, it is possible to charge the surplus electric power and the surplus electric power amount generated in a certain section in the storage battery 20 connected to the section. It is highly possible that the storage battery 20 connected to the same section as the electric power generation apparatus 30 generating the surplus electric power is positioned close to the electric power generation apparatus 30 generating the surplus electric power compared to the storage battery 20 connected to another section on the electric power distribution network. That is, according to the present invention, it is possible to charge the surplus electric power in the storage battery 20 that is highly possible to be positioned close to the electric power generation apparatus 30 generating the surplus electric power. Therefore, it is possible to narrow the range in which the variation of the voltage or the frequency may occur.

In addition, the surplus electric power and the surplus electric power amount generated in a certain section is charged in the storage battery 20 connected to the section. Therefore, it is possible to effectively reduce (cancel out) the variation of the voltage or the frequency by the surplus electric power.

In addition, according to the present example embodiment, in a case where it is impossible to completely charge the surplus electric power generated in a section in the storage battery 20 connected to the section, it is possible to charge the surplus electric power in the storage battery 20 connected to the section to which the electric power is supplied from the same electric power distribution station as the electric power distribution station that supplies the electric power to the section. Therefore, it is possible to effectively reduce (cancel out) the variation of the voltage or the frequency by the surplus electric power.

In addition, in this case, it is possible to preferentially perform the charge on the storage battery 20 connected to the section closer to the section where the surplus electric power is generated. As a result, it is possible to effectively reduce (cancel out) the variation of the voltage or the frequency by the surplus electric power. In addition, it is possible to narrow the range in which the variation of the voltage or the frequency may occur.

In addition, according to the present example embodiment, it is possible to charge the surplus electric power in the storage battery 20 installed in the vicinity (for example, the same section) of the electric power generation apparatus 30 that generates the surplus electric power. Therefore, it is possible to reduce an electric power transmission loss of the surplus electric power compared to a case where the charge is performed on the storage battery 20 installed at a position far away from the electric power generation apparatus 30. As a result, it is possible to increase a charge efficiency of the surplus electric power.

Note that, here, an example in which the electric power/electric power amount to be charged in the storage battery 20 are determined on the basis of the “predicted generation electric power/electric power amount” and the “electric power generation suppression information” is described. However, as a modification example, the electric power/electric power amount to be charged in the storage battery 20 may be determined on the basis of “rated generation electric power/rated electric power amount” and the “electric power generation suppression information”. In a case of the modification example, a value obtained by subtracting the generation electric power allowed at each timing of the electric power generation suppression time slot from the rated generation electric power is the electric power to be charged in the storage battery 20 at each timing. In addition, a value obtained by subtracting the generation electric power amount allowed in the electric power generation suppression time slot from the rated generation electric power amount is the electric power amount to be charged in the storage battery 20. The rated generation electric power amount is an electric power amount of a case where an electric power generation is continued in the rated generation electric power during the electric power generation suppression time slot. The generation electric power allowed at each timing and the generation electric power amount allowed in the electric power generation suppression time slot are determined on the basis of the electric power generation suppression information. The modification example is the same in all of the following example embodiments.

### Second Example Embodiment

The overall image of the control system of the present example embodiment is the same as that of the first example embodiment. The configurations of the storage battery 20 and the electric power generation apparatus 30 are the same as those of the first example embodiment.

FIG. 3 illustrates an example of a functional block diagram of the control apparatus 10. As shown in the drawing, the control apparatus 10 has the determination unit 11 and the decision unit 12. The configuration of the determination unit 11 is the same as that of the first example embodiment.

The decision unit 12 decides the storage battery to be controlled on which charging to be performed from among the plurality of storage batteries 20 to be managed, on the basis of the positional relationship (the magnitude of the distance) between the electric power generation apparatus 30 and the storage battery 20. The decision unit 12 decides the storage battery 20 installed closer to the first electric power generation apparatus 30 that generates the surplus electric power as the storage battery to be controlled more preferentially than other storage batteries 20. That is, the decision unit 12 decides the storage battery to be controlled in ascending order of the distance from the first electric power generation apparatus 30 that generates the surplus electric power. The decision unit 12 decides the storage battery to be controlled on the basis of information indicating installation positions of each storage battery 20 and each electric power generation apparatus 30 as shown in FIG. 4 and FIG. 5. Note that, in a case of the present example embodiment, the information indicating the section of the electric power distribution network as shown in FIGS. 6 to 8 is not necessary.

For example, the decision unit 12 decides the storage battery 20 installed closest to the first electric power generation apparatus 30 as the storage battery to be controlled to be charged with the surplus electric power and the surplus electric power amount of the first electric power generation apparatus 30. For example, the decision unit 12 may identify the storage battery 20 installed closest to the first electric power generation apparatus 30 in a straight line distance, on the basis of the information indicating the installation positions of each storage battery 20 and each electric power generation apparatus 30 as shown in FIG. 4 and FIG. 5, and may decide the storage battery 20 as the storage battery to be controlled. In addition, in a case where it is impossible to completely charge the surplus electric power and the surplus electric power amount in the storage battery to be controlled, the storage battery 20 of which the installation position is next closest to the electric power generation apparatus may further be decided as the storage battery to be controlled.

In the meanwhile, in a case where there are the plurality of electric power generation apparatuses 30 that generate the surplus electric power and the surplus electric power amount, the decision unit 12 may sequentially decide the storage battery to be controlled corresponding to each electric power generation apparatus 30, on the basis of the positional relationship between one electric power generation apparatus 30 and the plurality of storage batteries 20. In this case, the decision unit 12 may sequentially decide the storage battery to be controlled, using the plurality of electric power generation apparatuses 30 as a process target in descending order of the magnitude of the generated surplus electric power and/or the surplus electric power amount. A process of deciding the storage battery to be controlled corresponding to each electric power generation apparatus 30 is as described above (example: deciding the storage battery 20 as the storage battery to be controlled in ascending order of the distance from the installation position of each electric power generation apparatus 30).

As another example, the determination unit 11 may determine the total surplus electric power and the total surplus electric power amount by the plurality of electric power generation apparatuses 30. In addition, the decision unit 12 may decide the storage battery to be controlled to be charged with the total surplus electric power and the total surplus electric power amount by the plurality of electric power generation apparatuses 30. In this case, the decision unit 12 decides the storage battery to be controlled on the basis of the positional relationship between the predetermined position set with respect to the plurality of electric power generation apparatuses 30 and the plurality of storage batteries 20. A process of deciding the storage battery to be controlled is as described above (example: deciding the storage battery 20 as the storage battery to be controlled in ascending order of the distance from the predetermined position set with respect to the plurality of electric power generation apparatuses 30).

For example, the predetermined position set with respect to the plurality of electric power generation apparatuses 30 may be a center of gravity point (position) of the installation positions of the plurality of electric power generation apparatuses 30. In addition, the predetermined position may be a center of gravity point (position) in consideration of a weight (the magnitude of the surplus electric power of each of the plurality of electric power generation apparatuses 30). For example, the center of gravity point may be calculated by multiplying a coefficient decided according to the magnitude of the surplus electric power (the larger the surplus electric power, the larger the weight) by coordinates indicating each installation position.

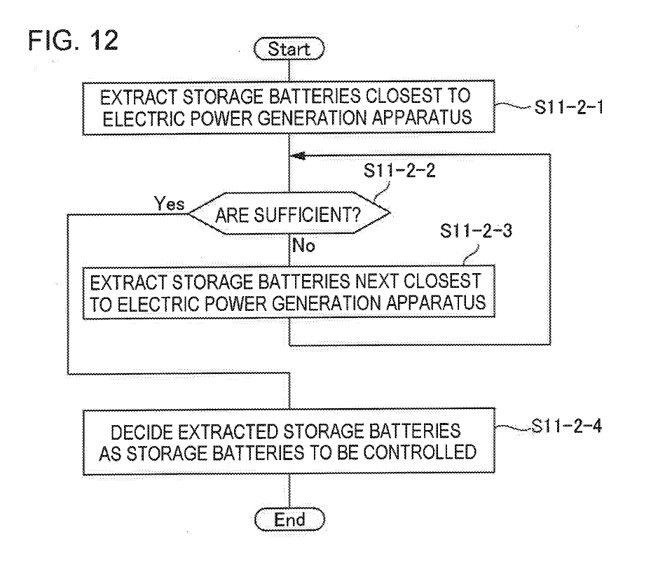

Next, an example of a flow of a process of the control apparatus 10 of the present example embodiment will be described. The overall image of the flow of the process of the control apparatus 10 is the same as that described in the first example embodiment. Hereinafter, the details of S11 in the present example embodiment will be described using a flowchart of FIG. 12.

First, in S10 of FIG. 9, the determination unit 11 calculates the time change of the surplus electric power [W] and the surplus electric power amount [Wh] for each electric power generation apparatus 30. The time change of the surplus electric power [W] and the surplus electric power amount [Wh] are determined as the time change of the charge electric power [W] and the charge amount [Wh] to be charged in the storage batteries 20. Here, it is assumed that the determination unit 11 calculates the time change of the surplus electric power [W] and the surplus electric power amount [Wh] of a process target electric power generation apparatus among the plurality of electric power generation apparatuses 30.

The decision unit 12 extracts L (L is an integer equal to or greater than one) storage batteries 20 in order from the storage battery installed close to the process target electric power generation apparatus (S11-2-1). Then, the decision unit 12 determines whether or not the extracted storage batteries 20 are sufficient (S11-2-2).

For example, the decision unit 12 determines whether or not “first condition: the sum of the controllable charge electric power maximum values [W] of the extracted storage batteries 20 is greater than the surplus electric power [W] at each timing” and “second condition: the sum of the maximum values [Wh] of the controllable empty capacities of the extracted storage batteries 20 is greater than the surplus electric power amount [Wh]” are satisfied.

In a case where both of the first condition and the second condition are satisfied, the decision unit 12 determines that the extracted storage batteries 20 are sufficient. On the other hand, in a case where at least one condition is not satisfied, the decision unit 12 determines that the extracted storage batteries 20 are not sufficient.

In a case where it is determined that the extracted storage batteries 20 are sufficient (Yes in S11-2-2), all of the storage batteries 20 that are extracted at that time point are decided as the storage batteries to be controlled (S11-2-4) and ends the process of S11.

On the other hand, in a case where it is determined that the extracted storage batteries 20 are not sufficient (No in S11-2-2), the decision unit 12 further extracts P (P is an integer equal to or greater than one) storage batteries 20 from among the storage batteries installed close to the process target electric power generation apparatus (S11-2-3). Then, the decision unit 12 determines whether or not the extracted storage batteries 20 are sufficient (S11-2-2). Thereafter, the same process is repeated.

According to the present example embodiment described above, in order from the storage battery 20 installed close to the electric power generation apparatus 30 that generates the surplus electric power, the storage battery to be controlled is decided. It is highly possible that the storage battery 20 of which the installation position is close to the electric power generation apparatus is also close to the electric power generation apparatus 30 on the electric power distribution network. Therefore, according to the present example embodiment, it is possible to expect the same advantageous effect as the first example embodiment.

### Third Example Embodiment

The overall image of the control system of the present example embodiment is the same as those of the first and second example embodiments. The configurations of the storage battery 20 and the electric power generation apparatus 30 are the same as those of the first and second example embodiments.

FIG. 3 illustrates an example of a functional block diagram of the control apparatus 10. As shown in the drawing, the control apparatus 10 has the determination unit 11 and the decision unit 12. The configuration of the determination unit 11 is the same as those of the first and second example embodiments.

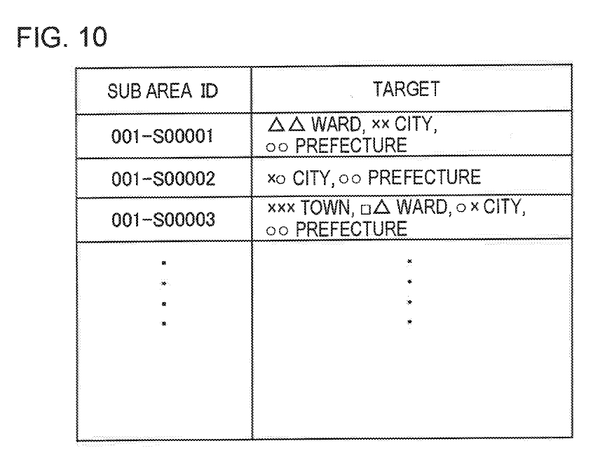

The decision unit 12 decides the storage battery to be controlled on which charging to be performed from among the plurality of storage batteries 20 to be managed, on the basis of the positional relationship between the electric power generation apparatus 30 and the storage battery 20. In the present example embodiment, as shown in FIG. 10, the area where the storage battery 20 and the electric power generation apparatus 30 are installed is divided into a plurality of sub areas on the basis of an address. The control apparatus 10 holds information as shown in FIG. 10.

In addition, the decision unit 12 decides the storage battery 20 installed in the same sub area as the first electric power generation apparatus 30 that generates the surplus electric power as the storage battery to be controlled.

It should be noted that in a case where it is impossible to completely charge the total surplus electric power and the total surplus electric power amount of a sub area in the storage battery 20 installed in the same sub area, the decision unit 12 may further decide the storage battery 20 installed in another sub area as the storage battery to be controlled. In this case, the decision unit 12 may preferentially decide the storage battery 20 installed in a closer sub area as the storage battery to be controlled than other storage batteries 20.

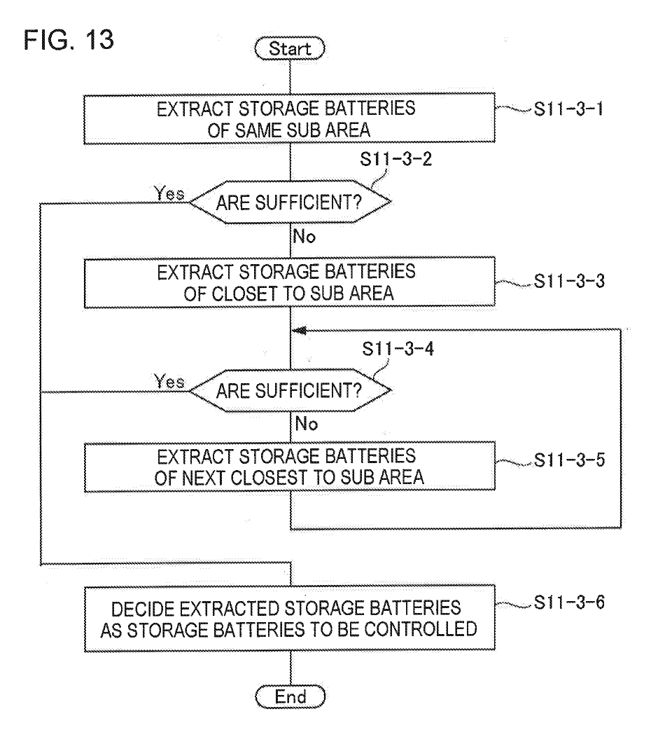

Next, an example of a flow of a process of the control apparatus 10 of the present example embodiment will be described. The overall image of the flow of the process of the control apparatus 10 is the same as that described in the first example embodiment. Hereinafter, the details of S11 in the present example embodiment will be described using a flowchart of FIG. 13.

First, in S10 of FIG. 9, the determination unit 11 calculates the time change of the total surplus electric power [W] and the total surplus electric power amount [Wh] of the first electric power generation apparatus 30 connected to each sub area for each sub area. The time change of the total surplus electric power [W] and the total surplus electric power amount [Wh] are the time change of the charge electric power [W] and the charge amount [Wh] to be charged in the storage batteries 20. Here, it is assumed that the determination unit 11 calculates the time change of the total surplus electric power [W] and the total surplus electric power amount [Wh] of a process target sub area among the plurality of sub areas.

The decision unit 12 extracts the storage batteries 20 installed in the process target sub area (S11-3-1). Then, the decision unit 12 determines whether or not the extracted storage batteries 20 are sufficient (S11-3-2).

For example, the decision unit 12 determines whether or not “first condition: the sum of the controllable charge electric power maximum values [W] of the extracted storage batteries 20 is greater than the surplus electric power [W] at each timing” and “second condition: the sum of the maximum values [Wh] of the controllable empty capacities of the extracted storage batteries 20 is greater than the surplus electric power amount [Wh]” are satisfied.

In a case where both of the first condition and the second condition are satisfied, the decision unit 12 determines that the extracted storage batteries 20 are sufficient. On the other hand, in a case where at least pone condition is not satisfied, the decision unit 12 determines that the extracted storage batteries 20 are not sufficient.

In a case where it is determined that the extracted storage batteries 20 are sufficient (Yes in S11-3-2), all of the storage batteries 20 that are extracted at that time point are decided as the storage batteries to be controlled (S11-3-6) and ends the process of S11.

On the other hand, in a case where it is determined that the extracted storage batteries 20 are not sufficient (No in S11-3-2), the decision unit 12 further extracts the storage batteries 20 installed in the sub area the closet to the process target sub area (S11-3-3). Then, the decision unit 12 determines whether or not the extracted storage batteries 20 are sufficient (S11-3-4). The process of S11-3-4 is the same as the process of S11-3-2.

In a case where it is determined that the extracted storage batteries 20 are sufficient (Yes in S11-3-4), all of the storage batteries 20 that are extracted at that time point are decided as the storage batteries to be controlled (S11-3-6) and ends the process of S11.

On the other hand, in a case where it is determined that the extracted storage batteries 20 are not sufficient (No in S11-3-4), the decision unit 12 further extracts the storage batteries 20 installed in the sub area that is next closest to the process target sub area (S11-3-5). Then, the decision unit 12 determines whether or not the extracted storage batteries 20 are sufficient (S11-3-4). Thereafter, the same process is repeated.

According to the present example embodiment described above, it is possible to decide the storage battery 20 installed in the same sub area as the electric power generation apparatus 30 that generates the surplus electric power as the storage battery to be controlled. It is highly possible that the storage battery 20 installed in the same sub area is close to the electric power generation apparatus 30 on the electric power distribution network. Therefore, according to the present example embodiment, it is possible to expect the same advantageous effect as the first and second example embodiments.

### Fourth Example Embodiment

The overall image of the control system of the present example embodiment is the same as those of the first to third example embodiments. The configurations of the storage battery 20 and the electric power generation apparatus 30 are the same as those of the first to third example embodiments.

FIG. 3 illustrates an example of a functional block diagram of the control apparatus 10. As shown in the drawing, the control apparatus 10 has the determination unit 11 and the decision unit 12.

In the first to third example embodiments, the determination unit 11 determines the charge electric power to be charged in the storage battery 20 on the basis of the electric power generation suppression information or the electric power generation prediction. The determination unit 11 of the present example embodiment determines the charge electric power to be charged in the storage battery 20 and the output electric power to be output from the storage battery 20 on the basis of an electric power generation actual measurement value of the electric power generation apparatus 30.

For example, in a case where the electric power generation actual measurement value is greater than an electric power generation target, the determination unit 11 determines the amount (surplus electric power) as the electric power to be charged in the storage battery 20. On the other hand, in a case where the electric power generation actual measurement value is less than the electric power generation target, the determination unit 11 determines the amount (deficient electric power) as the electric power to be output from the storage battery 20. The electric power generation target may be a predetermined fixed value or may be a moving average value of Q minutes (Q is a design matter. For example, 15 minutes, 30 minutes, and the like) of the electric power generation actual measurement value.

As an example, the determination unit 11 acquires the electric power generation actual measurement value [W] from each electric power generation apparatus 30 to be managed in real time. Them, the determination unit 11 calculates the surplus electric power and/or deficient electric power amount for each electric power generation apparatus 30 on the basis of the electric power generation actual measurement value and the electric power generation target. Then, the determination unit 11 calculates total surplus electric power [W] or total deficient electric power [W] by adding pieces of the surplus electric power and/or pieces of the deficient electric power of the electric power generation apparatuses 30 connected to each section for each section in proportion to the first example embodiment. The total surplus electric power [W] or the total deficient electric power [W] is determined as the charge electric power to be charged in the storage batteries 20 or the output electric power to be output from the storage batteries 20.

In a case of this example, the decision unit 12 decides the storage batteries 20 to be charged with the charge electric power or the storage batteries 20 to output the output electric power in a way similar to the first example embodiment (refer to FIG. 11). Note that in S11-1-2 and S11-1-4, “first condition: the sum of the controllable charge electric power maximum values [W] of the extracted storage batteries 20 is greater than the total surplus electric power [W] at each timing” or “first” condition: a sum of the controllable output electric power maximum values [W] of the extracted storage batteries 20 is greater than a total deficient electric power [W] at each timing” is determined. A controllable output electric power maximum value [W] may be the rated value of each storage battery to be controlled or may be a decision set between the manager of the control apparatus 10 and the manager of each of the plurality of storage batteries 20. In such a case, the control apparatus 10 may store the information in advance.

As another example, the determination unit 11 may calculate the surplus electric power [W] and/or deficient electric power [W] on the basis of the electric power generation actual measurement value and the electric power generation target for each electric power generation apparatus 30. The surplus electric power [W] or the deficient electric power [W] is determined as the charge electric power to be charged in the storage batteries 20 or the output electric power to be output from the storage batteries 20.

In a case of this example, the decision unit 12 decides the storage batteries 20 to be charged with the charge electric power or the storage batteries 20 to output the output electric power in a way similar to the second example embodiment (refer to FIG. 12). Note that in S11-2-2, “first condition: the sum of the controllable charge electric power maximum values [W] of the extracted storage batteries 20 is greater than the surplus electric power [W] at each timing” or “first” condition: the sum of the controllable output electric power maximum values [W] of the extracted storage batteries 20 is greater than the deficient electric power [W] at each timing” is determined.

In this example, in a case where there are the plurality of electric power generation apparatuses 30 that causes the surplus electric power or the deficient electric power, the decision unit 12 may decide the storage batteries to be controlled corresponding to each electric power generation apparatus 30, sequentially on the basis of the positional relationship between one electric power generation apparatus 30 and the plurality of storage batteries 20. In this case the decision unit 12 may sequentially set one among the plurality of electric power generation apparatuses 30 as the process target in descending order of the magnitude of the caused surplus electric power or deficient electric power to decide the storage batteries to be controlled. A process of deciding the storage batteries to be controlled corresponding to each electric power generation apparatus 30 is as described in the second example embodiment (example: deciding the storage batteries 20 as the storage batteries to be controlled in ascending order of the distance from the installation position of each electric power generation apparatus 30).

In addition, the determination unit 11 may determine the total surplus electric power or the total deficient electric power of the plurality of electric power generation apparatuses 30. In addition, the decision unit 12 may decide the storage batteries to be controlled to be charged with the total surplus electric power of the plurality of electric power generation apparatuses 30 or the storage batteries to be controlled to output the total deficient electric power. In this case, the decision unit 12 decides the storage batteries to be controlled on the basis of the positional relationship between the predetermined position set with respect to the plurality of electric power generation apparatuses 30 and the plurality of storage batteries 20. A process of deciding the storage batteries to be controlled is as described in the second example embodiment (example: deciding the storage batteries 20 as the storage batteries to be controlled in ascending order of the distance from the predetermined position set with respect to the plurality of electric power generation apparatuses 30).

For example, the predetermined position set with respect to the plurality of electric power generation apparatuses 30 may be a center of gravity point (position) of the installation positions of the plurality of electric power generation apparatuses 30. In addition, the predetermined position may be a center of gravity point (position) in consideration of a weight (the magnitude of the surplus electric power or the magnitude of the deficient electric power of each of the plurality of electric power generation apparatuses 30). For example, the center of gravity point may be calculated by multiplying a coefficient decided according to the magnitude of the surplus electric power or the magnitude of the deficient electric power (the larger the surplus electric power, the larger the weight, or the larger the deficient electric power, the larger the weight) by coordinates indicating each installation position.

As another example, after the determination unit 11 calculates the surplus electric power and/or the deficient electric power for each electric power generation apparatus 30 on the basis of the electric power generation actual measurement value and the electric power generation target, the determination unit 11 may calculate the total surplus electric power [W] or the total deficient electric power [W] by adding pieces of the surplus electric power and/or pieces of the deficient electric power of electric power generation apparatuses 30 installed in each sub area for each sub area in proportion to the third example embodiment. The total surplus electric power [W] or the total deficient electric power [W] is determined as the charge electric power to be charged in the storage batteries 20 or the output electric power to be output from the storage batteries 20.

In a case of this example, the decision unit 12 decides the storage batteries 20 to be charged with the charge electric power or the storage batteries 20 to output the output electric power in a way similar to the third example embodiment (refer to FIG. 13). Note that in S11-3-2 and S11-3-4, “first condition: the sum of the controllable charge electric power maximum values [W] of the extracted storage batteries 20 is greater than the total surplus electric power [W] at each timing” or “first” condition: the sum of the controllable output electric power maximum values [W] of the extracted storage batteries 20 is greater than the deficient electric power [W] at each timing” is determined.

According to the present example embodiment described above, it is possible to expect the same advantageous effect as the first to third example embodiments.

### Fifth Example Embodiment

The overall image of the control system of the present example embodiment is the same as those of the first to third example embodiments. The configurations of the storage battery 20 and the electric power generation apparatus 30 are the same as those of the first to third example embodiments.

FIG. 3 illustrates an example of a functional block diagram of the control apparatus 10. As shown in the drawing, the control apparatus 10 has the determination unit 11 and the decision unit 12.

The determination unit 11 determines the charge electric power to be charged in the storage battery in the same method as those of the first to third example embodiments.

The decision unit 12 decides the storage battery to be controlled in the same method as those of the first to third example embodiments (refer to FIGS. 11 to 13).

In addition, the decision unit 12 may decide the storage battery to be controlled by the following method. In a process of deciding the storage battery to be controlled, the decision unit 12 invites an owner of an electric vehicle preregistered in the control apparatus 10 for participation in a charge process using the electric vehicle. In the invitation, a time slot during which the charge process is performed, the charge amount [Wh], a charger used in the charge process, an incentive for the charge process, and the like are indicated. As the charger used in the charge process, a charger connected to the section where the total surplus electric power is generated, a charger installed in the sub area where the total surplus electric power is generated, a charger installed more closely to the electric power generation apparatus 30 that generates the surplus electric power, or the like may be selected by the decision unit 12. The decision unit 12 stores the installation position of each of a plurality of chargers in advance, and performs the above-described selection using the information. In addition, charge electric power [W] of each charger may be stored. The invitation is notified to a predetermined target through an e-mail, a social media, or the like.

The decision unit 12 decides an electric vehicle of a user who expressed the participation in the invitation as the storage battery to be controlled. In addition, the control apparatus 10 notifies the user of the electric vehicle decided as the storage battery to be controlled of a demand of the charge process. In the notification, the time slot during which the charge process is performed, the charge amount [Wh], the charger used in the charge process, the incentive for the charge process, and the like are indicated.

For example, the decision unit 12 may execute a process of deciding the electric vehicle as the storage battery to be controlled after the case of No in S11-1-2 of FIG. 11 and before S11-1-3. In addition, after the process, the same process as S11-1-2 is performed, and in the case of No, the process may proceed to S11-1-3.

In addition, for example, the decision unit 12 may execute a process of deciding the electric vehicle as the storage battery to be controlled after Nth (N is an integer equal to or greater than one) No in S11-1-4 of FIG. 11 and before Nth S11-1-5. In addition, after the process, the same process as S11-1-1 is performed, and in the case of No, the process may proceed to Nth S11-1-5.

In addition, for example, the decision unit 12 may execute a process of deciding the electric vehicle as the storage battery to be controlled after Nth (N is an integer equal to or greater than one) No in S11-2-2 of FIG. 12 and before Nth S11-2-3. In addition, after the process, the same process as S11-2-2 is performed, and in the case of No, the process may proceed to Nth S11-2-3.

In addition, for example, the decision unit 12 may execute a process of deciding the electric vehicle as the storage battery to be controlled after the case of No in S11-3-2 of FIG. 13 and before S11-3-3. In addition, after the process, the same process as S11-3-2 is performed, and in the case of No, the process may proceed to S11-3-3.

In addition, for example, the decision unit 12 may execute a process of deciding the electric vehicle as the storage battery to be controlled after Nth (N is an integer equal to or greater than one) No in S11-3-4 of FIG. 13 and before Nth S11-3-5. In addition, after the process, the same process as S11-3-4 is performed, and in the case of No, the process may proceed to Nth S11-3-5.

According to the present example embodiment, it is possible to charge the surplus electric power further using the electric vehicle. Since the electric vehicle is movable, it is possible to perform the charge using the charger connected to the section where the surplus electric power is generated, the charger installed in the sub area where the surplus electric power is generated, or the charger installed more closely to the electric power generation apparatus 30 that generates the surplus electric power. Therefore, it is possible to expect the same advantageous effect as the first to third example embodiments.

### Application Example

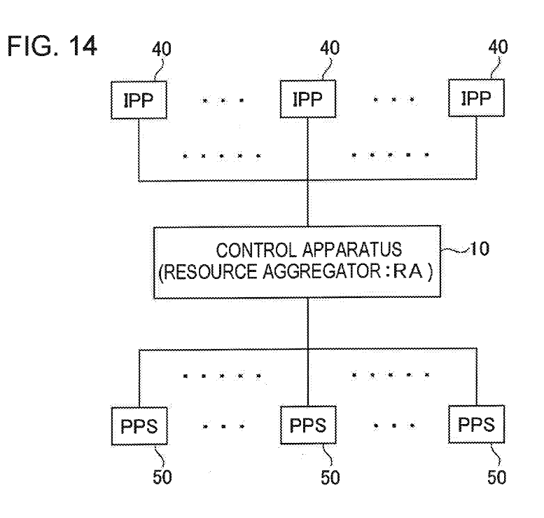

The application example of the control apparatus 10 of the present example embodiment will be described using FIG. 14. Each Independent Power Producer (IPP) 40 manages one or the plurality of electric power generation apparatuses 30. Each Power Producer and Supplier (PPS) manages one or the plurality of storage batteries 20.

The control apparatus 10 is managed by the Resource Aggregator (RA). The RA provides a service capable of avoiding output suppression with respect to the output suppression received by the IPP 40. The IPP 40 contracts with the RA to receive the service. In addition, the RA makes a contract with the PPS to control the charge and the discharge of the storage battery 20 for the above-described service.

The RA acquires the electric power generation suppression information notified to each IPP 40. The RA may acquire the electric power generation suppression information from each IPP 40 or may acquire the electric power generation suppression information of each IPP 40 from the manager of the electric power distribution network. For example, on the previous day, the electric power generation suppression information for the next day is notified.

The control apparatus 10 of the RA determines the charge electric power to be charged in the storage battery 20 (determination unit 11) and decides the storage battery to be controlled from among the plurality of storage batteries 20 on the basis of the positional relationship with the electric power generation apparatus 30 (decision unit 12), by the methods described in the first to third and fifth example embodiments. In addition, the control apparatus 10 decides the charge schedule in the electric power generation suppression time slot of each decided storage battery to be controlled and notifies the PPS 50 that manages each storage battery to be controlled of the charge schedule. The process so far is performed before the electric power generation suppression time slot indicated by the electric power generation suppression information.

The PPS 50 controls the storage battery 20 to cause the charge process to be performed according to the notified charge schedule during the electric power generation suppression time slot. The storage battery 20 receives the electric power supply from the electric power distribution network and is charged with the electric power. In addition, even during the electric power generation suppression time slot, the IPP 40 does not execute the electric power generation suppression according to the electric power generation suppression information and executes the electric power generation and the supply (reverse flow) to the electric power distribution network.

Hereinafter, an example of a reference form will be added.

1. A control apparatus including:

a determination unit that determines charge electric power to be charged in a storage battery and/or output electric power to be output from the storage battery, on the basis of generation electric power of an electric power generation apparatus; and

a decision unit that decides a storage battery to be controlled that is the storage battery for charging the charge electric power and/or outputting the output electric power, on the basis of a positional relationship between the electric power generation apparatus and a plurality of storage batteries.

2. The control apparatus according to 1,

in which the decision unit decides the storage battery to be controlled on the basis of a magnitude of a distance between the electric power generation apparatus and each of the plurality of storage batteries.

3. The control apparatus according to 1 or 2,

in which the decision unit decides the storage battery to be controlled in ascending order of the distance between the electric power generation apparatus and each of the plurality of storage batteries.

4. The control apparatus according to 1,

in which, in a case where there are a plurality of electric power generation apparatuses, the decision unit decides the storage battery to be controlled on the basis of a positional relationship between a predetermined position set with respect to the plurality of electric power generation apparatuses and the plurality of storage batteries.

5. The control apparatus according to 4,

in which the predetermined position is set on the basis of a magnitude of surplus electric power or deficient electric power for each of the plurality of electric power generation apparatuses.

6. The control apparatus according to 1,

in which in a case where there are a plurality of electric power generation apparatuses, the decision unit sequentially decides the storage battery to be controlled on the basis of a positional relationship between one electric power generation apparatus and the plurality of storage batteries.

7. The control apparatus according to 6,

in which the decision unit decides the storage battery to be controlled in an order of the magnitude of surplus electric power or deficient electric power for each of the plurality of electric power generation apparatuses.

8. The control apparatus according to any one of 1 to 7,

in which an electric power distribution network to which the electric power generation apparatus and the storage battery are connected is divided into a plurality of sections by a switch, and the decision unit decides the storage battery to be controlled on the basis of a positional relationship between the section to which the electric power generation apparatus is connected and the section to which the storage battery is connected.

9. The control apparatus according to 8,

in which the decision unit decides the storage battery connected to the same section as the electric power generation apparatus as the storage battery to be controlled.

10. The control apparatus according to 8,

in which the decision unit decides the storage battery connected to a section different from the section to which the electric power generation apparatus is connected as the storage battery to be controlled.

11. The control apparatus according to 10,

in which the decision unit decides the storage battery connected to a section to which electric power is supplied from the same electric power distribution station as an electric power distribution station that supplies electric power to the section to which the electric power generation apparatus is connected as the storage battery to be controlled.

12. The control apparatus according to 10,

in which the decision unit decides the storage battery as the storage battery to be controlled in an order from the storage battery that is connected to a section closer to the section to which the electric power generation apparatus is connected.

13. The control apparatus according to 1,

in which an area in which the electric power generation apparatus and the storage battery are installed is divided into a plurality of sub areas based on an address, the decision unit decides the storage battery installed in the same sub area as the electric power generation apparatus as the storage battery to be controlled.

14. A control method executed in a control apparatus that manages a plurality of storage batteries, the control method including:

determining charge electric power to be charged in the storage battery and/or output electric power to be output from the storage battery, on the basis of generation electric power of an electric power generation apparatus; and

deciding a storage battery to be controlled that is the storage battery for charging the charge electric power and/or outputting the output electric power, on the basis of a positional relationship between the electric power generation apparatus and the plurality of storage batteries.

15. A program that causes a computer to:

determine charge electric power to be charged in the storage battery and/or output electric power to be output from the storage battery, on the basis of generation electric power of an electric power generation apparatus; and

decide a storage battery to be controlled that is the storage battery for charging the charge electric power and/or outputting the output electric power from among a plurality of storage batteries, on the basis of a positional relationship with the electric power generation apparatus.

This application is based upon and claims the benefit of priority from Japanese Patent Application No. 2016-058002, filed on Mar. 23, 2016, the entire contents of which are incorporated herein by reference.

1. A control apparatus comprising:
at least one memory configured to store one or more instructions; and
at least one processor configured to execute the one or more instructions to:
determine charge electric power to be charged in a storage battery and/or output electric power to be output from the storage battery, on the basis of generation electric power of an electric power generation apparatus; and
decide a storage battery to be controlled that is the storage battery for charging the charge electric power and/or outputting the output electric power, on the basis of a positional relationship between the electric power generation apparatus and a plurality of storage batteries.

2. The control apparatus according to claim 1,
wherein the processor is further configured to execute the one or more programs to decide the storage battery to be controlled on the basis of a magnitude of a distance between the electric power generation apparatus and each of the plurality of storage batteries.

3. The control apparatus according to claim 1,
wherein the processor is further configured to execute the one or more programs to decide the storage battery to be controlled in ascending order of the distance between the electric power generation apparatus and each of the plurality of storage batteries.

4. The control apparatus according to claim 1,
Wherein the processor is further configured to execute the one or more pro rams to, in a case where there are a plurality of electric power generation apparatuses, decide the storage battery to be controlled on the basis of a positional relationship between a predetermined position set with respect to the plurality of electric power generation apparatuses and the plurality of storage batteries.

5. The control apparatus according to claim 4,
wherein the predetermined position is set on the basis of a magnitude of surplus electric power or deficient electric power for each of the plurality of electric power generation apparatuses.

6. The control apparatus according to claim 1,
Wherein the processor is further configured to execute the one or m e programs to, in a case where there are a plurality of electric power generation apparatuses, sequentially decide the storage battery to be controlled on the basis of a positional relationship between one electric power generation apparatus and the plurality of storage batteries.

7. The control apparatus according to claim 6,
wherein the processor is further configured to execute the one or more programs to decide the storage battery to be controlled in an order of the magnitude of surplus electric power or deficient electric power for each of the plurality of electric power generation apparatuses.

8. The control apparatus according to claim 1,
wherein an electric power distribution network to which the electric power generation apparatus and the storage battery are connected is divided into a plurality of sections by a switch, and
the processor is further configured to execute the one or more programs to decide the storage battery to be controlled on the basis of a positional relationship between the section to which the electric power generation apparatus is connected and the section to which the storage battery is connected.

9. The control apparatus according to claim 8,
wherein the processor is further configured to execute the one or more programs to decide the storage battery connected to the same section as the electric power generation apparatus as the storage battery to be controlled.

10. The control apparatus according to claim 8,
wherein the processor is further configured to execute the one or more orograms to decide the storage battery connected to a section different from the section to which the electric power generation apparatus is connected as the storage battery to be controlled.

11. The control apparatus according to claim 10,
wherein the processor is further configured to execute the one or more programs to decide the storage battery connected to a section to which electric power is supplied from the same electric power distribution station as an electric power distribution station that supplies electric power to the section to which the electric power generation apparatus is connected as the storage battery to be controlled.

12. The control apparatus according to claim 10,
wherein the processor is further configured t execute the one or more programs to decide the storage battery as the storage battery to be controlled in an order from the storage battery that is connected to a section closer to the section to which the electric power generation apparatus is connected.

13. The control apparatus according to claim 1,
wherein an area in which the electric power generation apparatus and the storage battery are installed is divided into a plurality of sub areas based on an address,
the processor is further configured to execute the one or more programs to decide the storage battery installed in the same sub area as the electric power generation apparatus as the storage battery to be controlled.

14. A control method executed in a control apparatus that manages a plurality of storage batteries, the control method comprising:
determining charge electric power to be charged in the storage battery and/or output electric power to be output from the storage battery, on the basis of generation electric power of an electric power generation apparatus; and
deciding a storage battery to be controlled that is the storage battery for charging the charge electric power and/or outputting the output electric power, on the basis of a positional relationship between the electric power generation apparatus and the plurality of storage batteries.

15. A non-transitory storage medium storing a program that causes a computer to:
determine charge electric power to be charged in the storage battery and/or output electric power to be output from the storage battery, on the basis of generation electric power of an electric power generation apparatus; and
decide a storage battery to be controlled that is the storage battery for charging the charge electric power and/or outputting the output electric power from among a plurality of storage batteries, on the basis of a positional relationship with the electric power generation apparatus.
